(19) United States
(12) Patent Application Publication
(10) Pub. No.: US 2014/0337975 A1
(43) Pub. Date: Nov. 13, 2014

(54) METHOD FOR ANALYZING SPYWARE AND COMPUTER SYSTEM

(71) Applicant: Tencent Technology (Shenzhen) Company Limited, Shenzhen (CN)

(72) Inventors: Zhi Wang, Shenzhen City (CN); Chunfu Jia, Shenzhen City (CN); Zan Zou, Shenzhen City (CN); Xiaokang Zhang, Shenzhen City (CN); Min Liu, Shenzhen City (CN)

(73) Assignee: Tencent Technology (Shenzhen) Company Limited, Shenzhen (CN)

(21) Appl. No.: 14/271,120

(22) Filed: May 6, 2014

Related U.S. Application Data
(63) Continuation of application No. PCT/CN2013/089032, filed on Dec. 11, 2013.

(30) Foreign Application Priority Data
May 8, 2013 (CN) 201310167166.8

(51) Int. Cl. H04L 29/06

(52) U.S. Cl. CPC H04L 63/1408
USPC 726/23

(57) ABSTRACT

A method for analyzing spyware and a computer system that relates to communication technology are provided. A trace of an executed spyware process is captured by the computer system. The spyware process includes a data packet returning operation that transmits a data packet to a control host as a result of executing the spyware process. The data packet returning operation has a subprogram which is extracted from the execution trace. The subprogram includes at least one call interface. Semantic information from each component of information of the at least one call interface is analyzed and output. In this manner a specific format of a data packet returned to the control host is determined, a communication protocol of the spyware is obtained, and a user may rewrite control commands of the spyware according to the obtained communication protocol, to control execution of the spyware.

The present application is a continuation of International Application No. PCT/CN2013/089032, filed on Dec. 11, 2013 which claims the priority to Chinese Patent Application No. 201310167166.8, entitled as “METHOD FOR ANALYZING SPYWARE AND COMPUTER SYSTEM,” filed on May 8, 2013 with State Intellectual Property Office of People's Republic of China, both of which are incorporated herein by reference in their entirety.

### FIELD

The present disclosure relates to the field of computer technology, and in particular to a method for analyzing spyware and a computer system.

### BACKGROUND

Malicious programs such as spyware develop gradually with the development of the Internet. A remote terminal such as a control host may control spyware executed by a computing device to forcibly inject malicious codes into an application process running on the computing device to obtain user information. Thus, user information may be leaked from the computing device.

### SUMMARY

A method for analyzing spyware and a computer system are provided by embodiments of the disclosure, by which the communication protocol of the spyware can be obtained by analyzing a returned data packet in the process of calling the spyware to communicate with a control host by a computer system, thus the execution of the spyware can be controlled.

A method for analyzing spyware is provided by an embodiment of the disclosure, including:

capturing an execution trace of a spyware process executed by a computer system;

extracting a subprogram of a data packet returning operation from the execution trace, wherein the data packet returning operation is an operation of transmitting a data packet to a control host while executing the spyware process by the computer system, and the subprogram of the data packet returning operation comprises information about at least one call interface; and

analyzing and outputting semantic information of each component of the information of the at least one call interface.

A computer system is provided by an embodiment of the disclosure, including:

a trace capturing unit, adapted to capture an execution trace of a spyware process executed by a computer system;

a return program extracting unit, adapted to extract a subprogram of a data packet returning operation from the execution trace, wherein the data packet returning operation is an operation of transmitting a data packet to a control host in executing the spyware process by the computer system, and the subprogram of the data packet returning operation comprises information of at least one call interface; and

a semantic information analyzing unit, adapted to analyze and output semantic information of each component of the information of the at least one call interface.

In the method for analyzing spyware provided by the embodiments of the disclosure, specific format of the returned data packet in calling the spyware to communicate with the control host by the computer system may be determined, communication protocol of the spyware may be obtained, and a user may rewrite the control command of the spyware according to the obtained communication protocol to control the execution of the spyware. For example, a control command rewritten by the user may include: controlling the spyware process to make it acquire other unimportant information rather than user information and returning the acquired unimportant information to the control host, thus leaking of the user information is avoided.

### BRIEF DESCRIPTION OF THE DRAWINGS

In order to illustrate technical solutions according to embodiments of the disclosure, the drawings to be used in the description of the embodiments of the disclosure will be described briefly hereinafter. The drawings described hereinafter include only some embodiments related to the present disclosure. Other drawings may be determined by those skilled in the art based on these drawings without any creative effort.

FIG. 1 is a flowchart of a method for analyzing spyware according to an embodiment of the disclosure.

FIG. 2 is a flowchart of a method for analyzing spyware according to an embodiment of the disclosure.

FIG. 3 is a flowchart of a method for analyzing spyware according to an embodiment of the disclosure.

FIG. 4 is a part of a call relationship graph according to an embodiment of the disclosure.

FIG. 5 is a flowchart of a method for analyzing spyware according to an embodiment of the disclosure.

FIG. 6 is a call relationship graph after performing dynamic slicing according to an embodiment of the disclosure.

FIG. 7 is a flowchart of a method for analyzing spyware according to an embodiment of the disclosure.

FIG. 8a is a flow diagram for dividing information in a send buffer by an ASI algorithm according to an embodiment of the disclosure.

FIG. 8b is a schematic structure diagram of each component of information in a send buffer according to an embodiment of the disclosure.

FIG. 9 is a schematic structure diagram of a computer system according to an embodiment of the disclosure.

FIG. 10 is a schematic structure diagram of a computer system according to an embodiment of the disclosure.

FIG. 11 is a schematic structure diagram of a computer system according to an embodiment of the disclosure.

FIG. 12 is a schematic structure diagram of a return program extracting unit in a computer system according to an embodiment of the disclosure.

FIG. 13 is a schematic structure diagram of a terminal to which a method for analyzing spyware is applied according to an embodiment of the disclosure.

### DETAILED DESCRIPTION

Technical solutions of the embodiments of the disclosure are described clearly and completely in conjunction with the drawings in the embodiments of the disclosure. Obviously, the described embodiments are only part of embodiments of the disclosure, and other embodiments made by those skilled in the art based on the embodiments of the disclosure without any creative work fall within the protection scope of the disclosure.

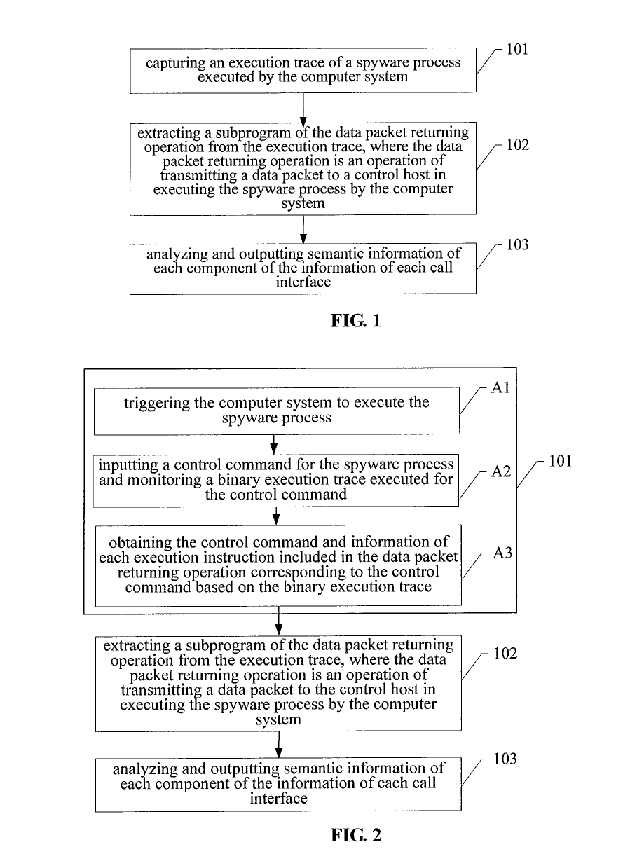

A method for analyzing spyware is disclosed, which includes analyzing a data packet returning operation performed during execution of the spyware by a computer system. The method may be performed by any computer system. As shown in FIG. 1, the method includes the following steps 101 to 103.

Step 101 may include capturing an execution trace of a spyware process executed by a computer system.

It is to be understood that an application process may be an active application, for example, an application whose codes have been put into a corresponding memory space by the computer system and which occupies certain system resources. An application may be referred to as a program before the application is called into the memory space, and may be referred to as a process after the application is called into the memory space and occupies resources. One process may include multiple threads, and each thread may realize a function. The memory space corresponding to each application is a space that stores application code in a storage module of the computer system, and each application corresponds to a memory space segment in the storage module.

The spyware may be a program which is generally controlled by a control host. It gathers information from the computer system and sends the gathered information to the control host without permission of the user of the computer system. The spyware includes, for example, a keylogger; a program that gathers sensitive information such as password, credit card number and PIN (personal identification number); and a program that gathers e-mail address and traces browsing habits. Generally, the control host controls the spyware to forcibly inject malicious code into an application process being executed by the computer system. Thus the computer system may call the spyware when executing the application process and user information in the computer system may be leaked. The computer system may communicate with the control host when executing the spyware process, and communication protocol used by the spyware may be obtained by analysis in view of the various forms of spyware. Therefore, the control commands of the spyware may be rewritten according to the obtained communication protocol, and the execution of the spyware process can be controlled to avoid leaking of the user information.

In this embodiment, in order to analyze the spyware, the computer system may trigger the spyware process to start, and capture the execution trace while executing the spyware process by the computer system. The execution trace herein may refer to an execution record of a program process in time sequence, including, for example, process information, module information, information about a thread included in the process, an instruction for executing a spyware process by a computer, an instruction operand, an operand taint mark and register status.

Step 102 may include extracting a subprogram of a data packet returning operation from the execution trace, where the data packet returning operation is an operation including transmitting a data packet to the control host as a result of executing the spyware process by the computer system. In the step 102, the returned data packet may be obtained and then transmitted to the control host. The subprogram of the data packet returning operation may include information about multiple call interfaces.

The process of executing the spyware process by the computer system may include operations of multiple threads, and each thread may realize a certain function. In each thread, the computer system may call multiple interfaces, for example, application programming interfaces (API). The call interfaces may include, for example, an interface for receiving a data packet (for example, recv interface function), an interface for outputting a returned data packet (for example, send interface function) and an interface for opening a file.

In this embodiment, the subprogram of the data packet returning operation, which may be referred to as a thread, may be analyzed. Because the computer system communicates with the control host when executing the spyware process, each data packet returning operation may correspond to at least one data packet receiving operation. The returned data packet may be a data packet sent in response to a received data packet, such as a data packet sent in response to a bot.dns command, which may be a query command for DNS (Domain Name System). The subprogram of the data packet returning operation may further include multiple call interfaces such as a call interface for gathering user information and the call interface for outputting the returned data packet. In this embodiment, because the execution trace obtained in step 101 includes call interfaces that are called by the computer system in each thread, the computer system may extract, from the execution trace, information about one or more other second call interfaces which affect the call of the first call interface for outputting the returned data packet, and the one or more other second call interfaces and the first call interface for outputting the returned data packet may constitute the subprogram of the data packet returning operation.

Step 103 may include analyzing and outputting semantic information of each component of information of each call interface in the subprogram of the data packet returning operation obtained in step 102, so that the format of the returned data packet is obtained and the communication protocol of the spyware is obtained.

The information of the call interface may include multiple components, such as length and specific content. In performing the analysis in step 103, the information of each call interface may be divided into multiple components by an ASI (Aggregate Structure Identification) algorithm. The semantic information of each component may be obtained by a certain method. In the ASI algorithm, each struct that may include information of the call interface may be taken as a byte set with a given length, and the struct may be divided into several parts according to its access mode.

It can be seen that, in the method for analyzing spyware provided by the embodiment of the disclosure, the computer system may capture an execution trace of a spyware process executed by the computer system; then extract the subprogram of a data packet returning operation from the execution trace, where the data packet returning operation is an operation of transmitting a data packet to a control host by the computer system in executing the spyware process by the computer system; and finally analyze and output the semantic information of each component of the information of the call interface included in the subprogram of the data packet returning operation. Therefore, specific format of the returned data packet in calling the spyware to communicate with the control host by the computer system may be determined, communication protocol of the spyware can be obtained, and the user may rewrite the control command of the spyware according to the obtained communication protocol to control the execution of the spyware. For example, a control command rewritten by the user may include: controlling the spyware process to make it acquire other unimportant information rather than user information and returning the acquired unimportant information to the control host, thus leaking of the user information is avoided.

As shown in FIG. 2, in an embodiment, the following steps A1 to A3 may be performed for step 101 by the computer system.

Step A1 may include triggering the computer system to execute the spyware process. In this embodiment, in order to analyze the spyware, the computer system executes the spyware process first. In an implementation, a simulator in the computer system may be used to execute the spyware process directly, without injecting the spyware into another application process.

Step A2 may include inputting a control command for the spyware process and monitoring a binary execution trace executed by the computer system for the control command. Specifically, the user may input any control command via an interface provided by the simulator of the computer system and monitor by the simulator the execution trace of executing the control command.

Step A3 may include obtaining, based on the binary execution trace, the control command and information of each execution instruction included in the data packet returning operation corresponding to the control command. Because assembly codes are easy to be analyzed, codes which can be executed directly by the computer system, for example, codes included in the binary execution trace may be transformed into assembly codes by an assembly mechanism provided by the simulator platform of the computer system in performing Step A3. The format of each obtained execution instruction may be: “address: assembly instruction data stored in the register or memory which participates in the operation taint information,” where the taint information may represent whether the data participating in the operation is tainted or marked. The propagation of the tainted data may be traced. For example, “719c3c9c: test % eax, % eax R@eax[0x00000000][4](R) T0 R@eax[0x 00000000][4](R) T0.”

The obtained information of each execution instruction is as shown in Table 1:

TABLE 1

| Name | Meaning |
|---|---|
| Ins_addr | address of execution instruction, sometimes the entry |
| | address of a certain interface function |
| Type | type of execution instruction operation |
| Address | address of operand (i.e., data participating in instruction |
| | operation) of execution instruction operation |
| Value | contents of operand |
| Taint | taint mark, 0 (no taint) or 1 (taint) |
| Origin | different fields correspond to different taint sources if |
| | it is taint |
| Offset | offset of taint operand in the same taint source |

It can be seen that, the execution trace in assembly format may be obtained from Step A1 to Step A3, which facilitates the later analysis of the spyware based on the execution trace.

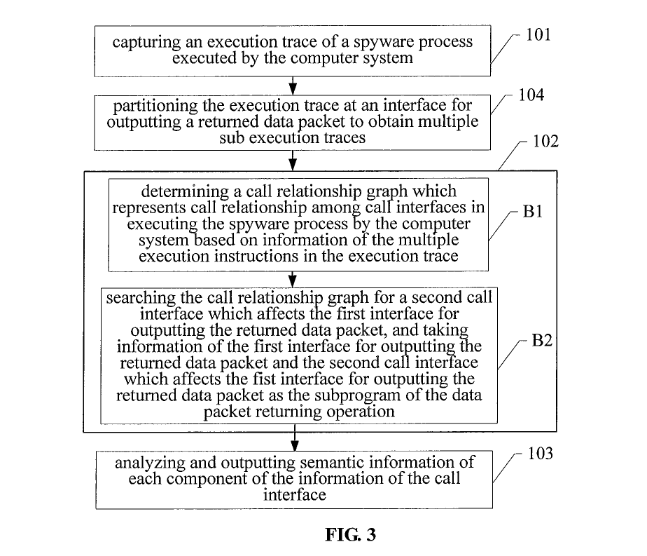

As shown in FIG. 3, in some embodiments, because the execution trace obtained in step 101 may include multiple sub processes of receiving and returning the data packets in executing the spyware process by the computer system, in order to simplify the analysis, the computer system may perform a preliminary filtering on the execution trace before performing step 102, to obtain and analyze sub processes of data packet receiving and data packet returning. That is, before performing step 102, the computer system may perform step 104, which may include partitioning the execution trace obtained in step 101 at the interface for outputting the returned data packet, to get multiple sub execution traces, and each sub execution trace may include an execution trace of a sub process from receiving a data packet from the control host to outputting the returned data packet to the control host by the computer system. In this case, the computer system may extract the subprogram of the data packet returning operation from any sub execution trace in performing step 102.

The following steps B1 to B2 may be performed for step 102 by the computer system.

Step B1 may include determining a call relationship graph which represents call relationship among call interfaces in executing the spyware process by the computer system based on the information from multiple execution instructions in the execution trace which may comprise a sub execution trace in this embodiment. The call relationship graph may represent relationships among the call interfaces in performing a function by the computer system, which may be obtained by a construction algorithm proposed by S. Horwitz et al.

When the computer system calls an interface, there may be an entry instruction, which may include a call instruction in the assembly level, and the computer system may enter into the function body of the call interface to execute the function. Furthermore, there may be an exit instruction, which may include a ret instruction when the execution is finished. There may be multiple pairs of call and ret instructions instances when there are nested calls for an interface. In this case, the computer system may search the call instructions from an outer layer to an inner layer and search the ret instructions from the inner layer to the outer layer according to the sequence of the execution instructions. Thus instruction pairs may be paired, and each instruction pair may correspond to a call interface. For example, part of the execution instructions in the execution trace may be as shown in the following Table 2:

TABLE 2
1 call-0 X 7c921166 LdrInitializeThunk (DLL loading and connecting)

| | |
|---|---|
| 2 | omitted |

```
  3 ret
  4 call-7c92d040 ZwContinue
```

| | |
|---|---|
| 5 | call-0 X 7c92e4f0 KiFastSystemCall |

| | |
|---|---|
| 6 | call-7c8024d6 |
| 7 | ret |
| 8 | call-0 X 7c93b08a computer systemrNewThread |

| | |
|---|---|
| 9 | call-7c92d9f0 ZwRegisterThreadTerminatePort |

| | |
|---|---|
| 10 | call-0 X 7c92e4f0 KiFastSystemCall |
| 11 | ret |

| | |
|---|---|
| 12 | ret |

| | |
|---|---|
| 13 | ret |
| 14 | call-0 X 0040b657 |

| | |
|---|---|
| 15 | call-00429640_{——}EH_prolog |
| 16 | ret |
| 17 | call-0 X 004134f4 Run( ) |

| | |
|---|---|
| 18 | call-00429640_{——}EH_prolog |
| 19 | ret |
| 20 | call-00406119 Recv(char*,bool) |

| | |
|---|---|
| 21 | call-00429640_{——}EH_prolog |
| 22 | ret |
| 23 | call-0040aede |

It can be seen that, in Table 2, a call instruction in line 1 and a ret instruction in line 3 are an instruction pair, a call instruction in line 6 and a ret instruction in line 7 are an instruction pair, a call instruction in line 8 and a ret instruction in line 13 are an instruction pair, a call instruction in line 9 and a ret instruction in line 12 are an instruction pair, a call instruction in line 10 and a ret instruction in line 11 are an instruction pair, a call instruction in line 15 and a ret instruction in line 16 are an instruction pair, a call instruction in line 18 and a ret instruction in line 19 are an instruction pair, and a call instruction in line 21 and a ret instruction in line 22 are an instruction pair. In searching the instruction pairs, a call instruction and a ret instruction with the same indent amount may be searched.

Therefore, in determining the call relationship graph in this step, the computer system may search multiple execution instructions of the execution trace which may include a sub execution trace in this embodiment, for entry instructions and exit instructions for calling each interface; then identify the entry instruction or exit instruction as a call node, and connect the call nodes having a call relationship with call lines. Each call node may represent a call interface statement, and a start address of the call interface is included in the call node. In a case that there is a call relationship between two interfaces, for example, before calling an interface for outputting a returned data packet, an interface for opening a file and obtaining information needs to be called first, then there is a call relationship between the interface for outputting the returned data packet and the interface for opening a file and obtaining information, and the call nodes corresponding to the two interfaces are connected with a call line.

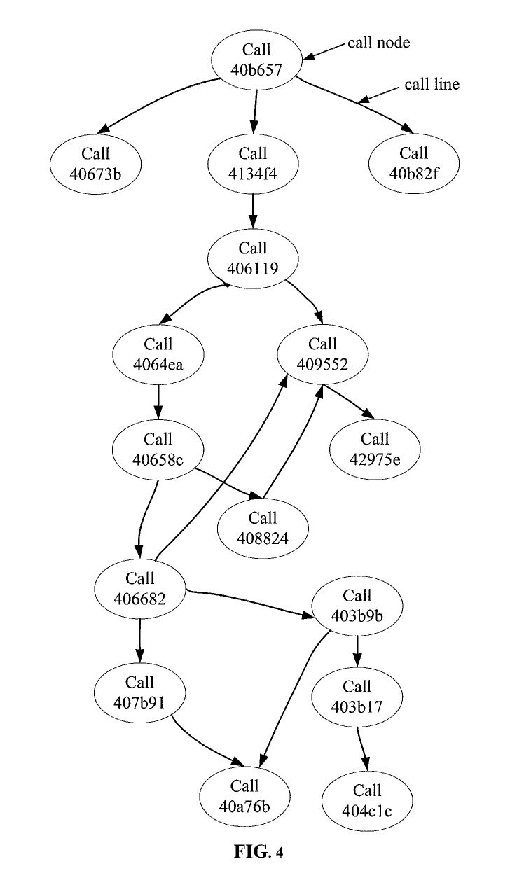

For example, in the part of the call relationship graph as shown in FIG. 4, each call node includes an entry instruction and a start address of the call interface, and the two call nodes having call relationship are connected with a call line (the arrow in FIG. 4). The ret instruction paired with each call instruction is not shown in the call relationship graph in FIG. 4, and the call relationship between the interfaces is indicated by the call instruction only, with the ret instruction being omitted.

Step B2, may include searching the call relationship graph for a second call interface which affects the first call interface for outputting the returned data packet, and identifying information of the first call interface for outputting the returned data packet and the second call interface which affects the first call interface for outputting the returned data packet as the subprogram of the data packet returning operation.

The computer system may perform dynamic slicing on the call relationship graph by using a dynamic slicing method, and obtain the second call interface which affects the call of the first call interface for outputting the returned data packet. A dynamic slicing refers to a slicing obtained by performing dynamic slicing on a program according to a slicing criterion, for example, a Weiser slicing. The slicing criterion may be presented by <n, V>, in which n represents an interesting point in the program and generally refers to a statement, and V represents a set of variables used in this statement. For example, slicing S of program P may be obtained by deleting zero or multiple statements in program P, and the functions of program P and the obtained slicing S are guaranteed to be the same for the slicing criterion. In addition, if considering a specific input Iₒ for program P when performing dynamic slicing on program P, the computer system may calculate all the statements and predicate set of program P which affect the value of V at point n under the condition of the specific input Iₒ, then the obtained slicing criterion is <n, V, Iₒ>.

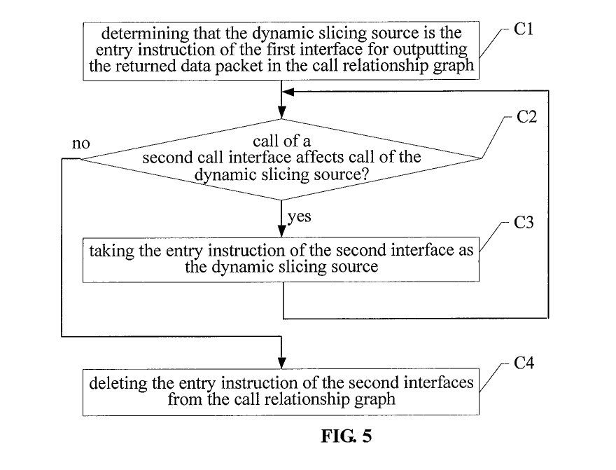

As shown in FIG. 5, in this embodiment, the interesting point n is the determined dynamic slicing source, and the following steps C1 to C4 may be performed for step B2 by the computer system.

Step C1, may include determining that the dynamic slicing source is an entry instruction of the first call interface for outputting the returned data packet in the call relationship graph.

In determining the dynamic slicing source, the computer system may determine, in the execution trace, the entry address of the first call interface for outputting the returned data packet, such as the instruction register (EIP) of send function, which may be 0x71a24c27, for example. Then the call relationship graph may be searched for the entry instruction corresponding to the entry address, which may include a call node in the call relationship graph.

Step C2, may include iteratively judging whether a call of a second call interface affects the call of the dynamic slicing source, which may include judging whether the dynamic slicing source is affected by the called function of a second call interface. Step C3 may be performed in instances when the call of the second call interface affects the call of the dynamic slicing source, for example, a function parameter of the second call interface is propagated to a function parameter of the dynamic slicing source. Step C4 may be performed in instances when the call of the second call interface does not affect the call of the dynamic slicing source.

Step C3, may include identifying or setting the entry instruction of the second call interface as the dynamic slicing source and returning to perform Step C2, until Step C2 is performed for entry instructions of all the call nodes in the call relationship graph.

Step C4, may include deleting the entry instruction of the second call interface from the call relationship graph.

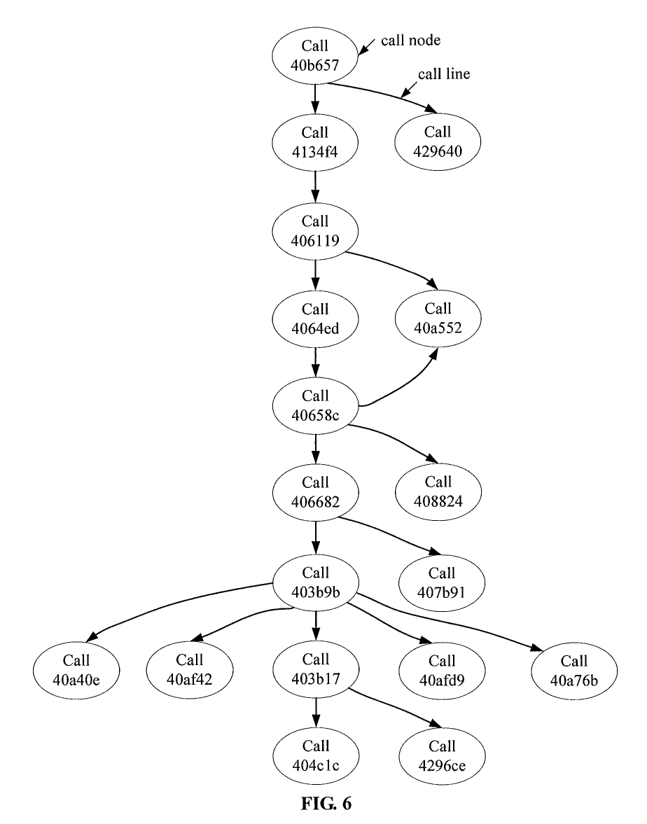

For example, as shown in FIG. 6, the sliced call relationship graph is obtained by performing dynamic slicing on the call relationship graph in FIG. 4, and each call node includes an entry instruction, which may comprise a call instruction, and a start address for calling an interface. The call interface corresponding to call node call-404c1c may be the first call interface for outputting the returned data packet, and the first call interface for outputting the returned data packet may be called in the entry instruction of the call node (for example, the send function) to output the returned data packet. The top call node call-40b657 may correspond to the thread for establishing the data packet returning operation.

It is to be noted that the presentation of the first call interface and the second call interface is not intended to represent a sequence of the interfaces, but is only for distinguishing the interfaces.

By Step B1 and Step B2 in this embodiment, the other second call interface which affects the call of the first call interface for outputting the returned data packet may be obtained, which further simplifies the analysis of the spyware.

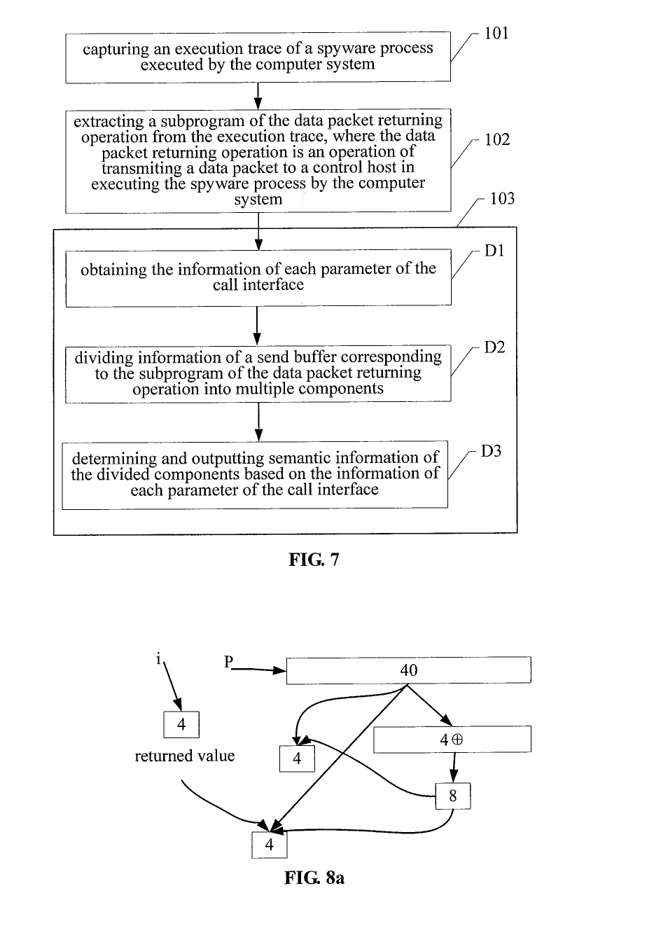

As shown in FIG. 7, in an embodiment, the following steps D1 to D3 may be performed for step 103 by the computer system.

Step D1, obtaining information of each parameter of each call interface in the subprogram of the data packet returning operation.

It can be understood that, the semantic information of each parameter of an operating system interface being called in a computer system, such as a system interface, an application interface and an interface in a dynamic linking library, may be published by a supplier of the operating system and stored in an interface database. For example, the output interface of TCP (Transmission Control Protocol) is send, and prototype information for calling the output interface by the computer system stored in the interface database may be: the second parameter is the first address of the output data, and the third parameter is the length of the output data.

Generally, in executing the spyware process by the computer system, the contents of the returned data packet transmitted to the control host by the computer system may include, for example, the time of the target host, and host information such as name, ports and local IP of the host. The data packet returning operation may involve calling multiple system interfaces, for example, the interface between the application of the operating system and the bottom of the operating system, and the computer system can complete corresponding service only by calling the system interface. The involved system interface may include, for example, a file operation interface, a process operation interface, a registry operation interface, a network interface, a system service interface and a string processing interface; all the prototype information of these call interfaces may be stored in an interface database, including information such as the prototype, the interface name, the interface function and the returned value of each call interface, and parameter information such as the type and the meaning of the parameter.

In this embodiment, in performing Step D1, the computer system may search the subprogram of the data packet returning operation for all information of the call interface corresponding to each call node in the call relationship graph, but the computer system may not know the meaning of the parameters in the information of the call interfaces. The computer system may further search the interface database for the prototype information of the call interfaces by the entry instruction address of the call interface, for example, the second parameter of the send interface is the first address of output data and the third parameter is the length of output data, so the information of the parameters of the call interfaces may be obtained according to the prototype information.

In searching the subprogram of the data packet returning operation for the information of the call interface by the computer system, in instances when the information of each call interface in the subprogram of the data packet returning operation includes continuous code segments, it may be easy for the computer system to find all the information of each call interface. The information between the entry instruction and the exit instruction may comprise all of the information of the call interface. Therefore, in this instance, the computer system may only need to obtain the entry instruction and exit instruction of each call interface.

In instances when the subprogram of the data packet returning operation includes non-continuous code segments, for example, where the information of each call interface includes non-continuous code segments, in searching the subprogram of the data packet returning operation for the information of the call interface, the computer system may find all the information of the call interface according to the displacement information generated when calling the call interface in the execution trace. The displacement information herein refers to information about the distance between two parameters of the call interface when being called, which may be measured by the number of call statements, thus after determining the information of one parameter of the call interface, the computer system may further determine another parameter's information of the call interface based on the displacement information, and so on, until all the information of the call interface is found.

Step D2, may include dividing information of the send buffer corresponding to the subprogram of the data packet returning operation into multiple components.

It should be noted that after the computer system calls each call interface in the subprogram of the data packet returning operation, the information about the returned data packet needed to be sent by the computer system may be included in the send buffer corresponding to the subprogram of the data packet returning operation, and the information may be arranged in byte order. The computer system may divide the information of the send buffer into multiple cells with semantic information by the ASI algorithm, and each cell may be in a unit of byte and may be a byte sequence with multiple bytes. The semantic information of each cell may be obtained by performing the following Step D3 by the computer system.

In the ASI algorithm, the manner that the computer system accesses data to be analyzed is specified by DAC (data-access constraint language), and the DAC may be specified by the following program:

Pgm :: == ∈ | UnifyConstraint Pgm
UnifyConstraint :: == DataRef≈DataRef
DataRef ::== ProgVars | DataRef [int: int] | DataRef\Int₊

In the above DAC program, DataRef represents a series of bytes, for example, the struct to be analyzed or the program to be analyzed; UnifyConstraint records the direction of the data flow in the program to be analyzed. The direction of the data flow does not include the direct data flow in the program, because for a direct data flow, such as a data flow from one DataRef to another DataRef, it may be considered that the two DataRefs have the same structure. In addition, ≈ represents the direction of the data flow, int is a nonnegative integer, Int₊ is a positive, and ProgVars is a variable set of the program. The above DAC program indicates the following three data references: (1) variable PεProgVars represents all bytes of variable P; (2) DataRef[1:u] represents the bytes from 1 to u in DataRef, for example, P[8:11] represents the eighth byte to the eleventh byte of variable P; (3) DataRef\n represents an array including n elements, for example, P[0:11]544 3 represents a series of bytes P[0:3], P[4:7] or P[8:11].

For example, the access constraint of the information of the call interface in the subprogram of the data packet returning operation includes:

P[0:39]\5[0:3]≈const_{—}1[0:3], which represents assigning x of each element in array P (including 5 elements) with 1, for example, P[i].x=1;

P[0:39]\5[4:7]≈const_{—}2[0:3], which represents assigning y of each element in array P with 2, for example, P[i].y=2;

Return_main[0:3]≈P[4:7], which represents that the returned value is the fourth byte to the seventh byte in array P, and the returned value is the actual returned value of the analyzed program, for example, the value of p[0].y.

Thus in the ASI algorithm, the access manner of the program to be analyzed in the send buffer may be specified by the DAC program, and the minimum cell of the data to be accessed may be determined.

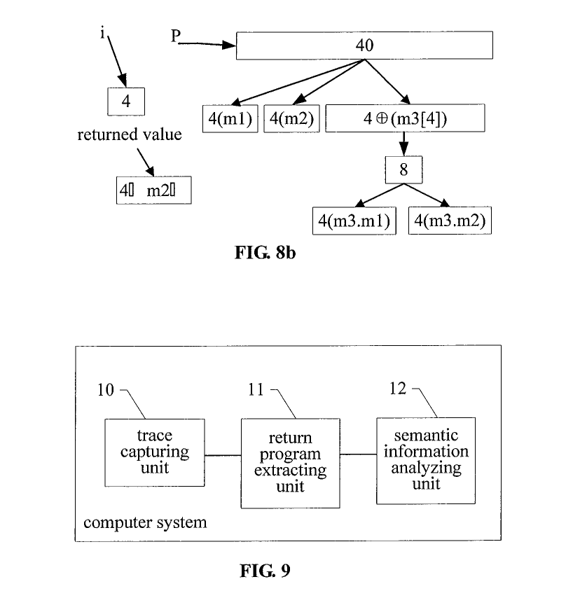

According to the above ASI algorithm, the information in the send buffer may be divided into multiple components, such as the direction of dividing the information of the send buffer shown in FIG. 8a, and the components of the information of the send buffer shown in FIG. 8b, in which each leaf node represents a minimum cell which cannot be divided further and represents a series of bytes in struct P; an array node is marked with ⊕, and the numerical value in the array node represent the number of array elements. An analyzed program with a total length of 40 bytes may be divided into 2 specific values (that is, two values each with 4 bytes, for example, m1 and m2) and an array m3[4], for example, P[8:39], in which array m3[4] may be further divided into arrays each with 4 array elements, each array element may include 8 bytes, and the 8 bytes may include 2 nodes each with 4 bytes, for example, m3.m1 and m3.m2. P[4:7] may be included in multiple components, thus this node may be a shared node and a returned value.

Step D3, may include determining and outputting the semantic information from each component divided in Step D2 according to the information of each parameter of the call interface obtained in Step D1.

The computer system may obtain the parameter information of each call interface by performing Step D1, such as the first address of each parameter. A taint propagation technology may be adopted for Step D3, that is, the computer system may first taint the parameters of each call interface included in the subprogram of the data packet returning operation obtained in Step 102, and then observe which parameters are propagated to the address space of the send buffer corresponding to the subprogram of the data packet returning operation. If there is a parameter which is propagated to the send buffer and the length of this parameter is the same as the length of the cell obtained in Step D2, the semantic information of this cell in the send buffer may be the semantic information of a tainted parameter, and the semantic information of the parameter is obtained in Step D1.

The tainting for the parameter of each call interface may begin from the first address of the parameter of the call interface, and the entire address space that the parameter locates may be tainted, for example, each byte of the parameter may be tainted, and the granularity of the taint may be in byte level, where each byte has an unique taint mark. For example, a parameter of a call interface may include 4 bytes, and the 4 bytes of the parameter may be marked with different taint marks respectively.

For example, by the above ASI algorithm and taint propagation technology, the returned data packet for the bot.dns command may include the format as shown in the following Table 3:

TABLE 3

| offset | length | Semantic information | content |
|---|---|---|---|
| [0-6] | 7 | sending string command | PRIVMSG |
| 7 | 1 | space | 0x20 |
| [8-13] | 6 | message receiver | #liulu |
| 14 | 1 | space | 0x20 |
| 15 | 1 | : | 0x3a |
| [16-47] | 32 | DNS query result | www.baidu.com |
| | | | −>220.181.111.147 |
| [48-49] | 2 | linefeed | 0d 0a |

A computer system is provided by an embodiment of the disclosure, and a sequence performed by each unit may refer to the above flow of the spyware analysis method.

FIG. 9 illustrates a structure diagram of the computer system, which may include:

a trace capturing unit 10, adapted to capture an execution trace of a spyware process executed by a computer system;

a return program extracting unit 11, adapted to extract a subprogram of a data packet returning operation from the execution trace captured by the trace capturing unit 10, where the data packet returning operation may be an operation of transmitting a data packet to a control host in executing the spyware process by the computer system, and the subprogram of the data packet returning operation may include information about multiple call interfaces;

a semantic information analyzing unit 12, adapted to analyze and output semantic information from each component of information of the call interface included in the subprogram of the data packet returning operation extracted by the return program extracting unit 11.

In the computer system provided by the embodiment of the disclosure, the trace capturing unit 10 may first capture an execution trace of a spyware process executed by a computer system. The return program extracting unit 11 may extract a subprogram of a data packet returning operation from the execution trace, where the data packet returning operation may comprise an operation including transmitting a data packet to a control host by executing the spyware process by the computer system. The semantic information analyzing unit 12 may analyze and then output semantic information from components of the information of the call interface included in the subprogram of the data packet returning operation. Therefore, specific format of the returned data packet in calling the spyware to communicate with the control host by the computer system may be determined, communication protocol of the spyware may be obtained, and the user can rewrite the control command of the spyware according to the obtained communication protocol to control the execution of the spyware. For example, a control command rewritten by the user may include: controlling the spyware process to make it acquire other unimportant information rather than user information and returning the acquired unimportant information to the control host, thus leaking of the user information may be avoided.

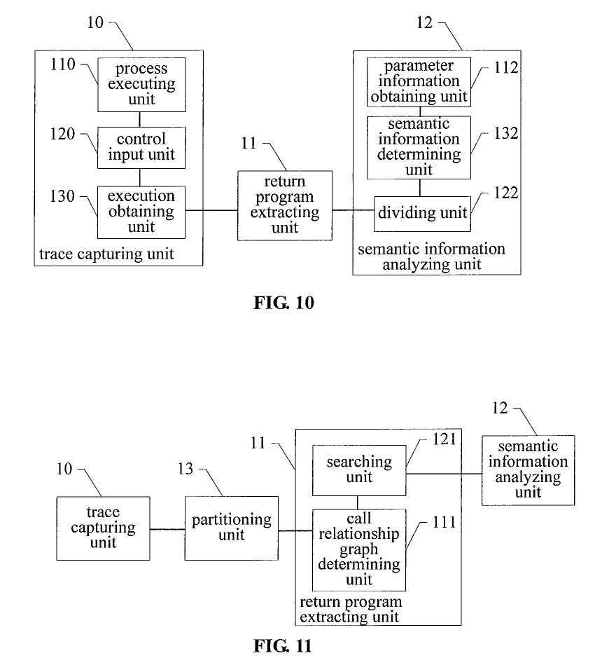

As shown in FIG. 10, in an embodiment, based on the structure as shown in FIG. 9, the trace capturing unit 10 may further include a process executing unit 110, a control input unit 120 and an execution obtaining unit 130 The semantic information analyzing unit 12 may further include a parameter information obtaining unit 112, a dividing unit 122 and a semantic information determining unit 132.

The process executing unit 110 may be adapted to trigger the computer system to execute the spyware process.

The control input unit 120 may be adapted to input a control command for the spyware process and monitor a binary execution trace executed by the computer system for the control command. A user may input any control command via an interface provided by the control input unit 120, and monitor the execution trace executed by the process executing unit 110 for the control command.

The execution obtaining unit 130 may be adapted to obtain the control command and information of each execution instruction included in the data packet returning operation corresponding to the control command according to the binary execution trace monitored by the control input unit 120. The execution obtaining unit 130 may transform codes which can be executed directly by the computer system, for example, codes included in the binary execution trace, into assembly codes, by disassembling. The format of each obtained execution instruction may be: “address: assembly instruction data stored in the register or the storage which participates in the operation taint information.”

The parameter information obtaining unit 112 may be adapted to obtain information of each parameter of each call interface in the subprogram of the data packet returning operation extracted by the return program extracting unit 11. The parameter information obtaining unit 112 may search the subprogram of the data packet returning operation for information of each call interface; search an interface database for prototype information of the call interface, and obtain information of each parameter of the call interface based on the prototype information.

In searching the information of each call interface, in instances when the information of each call interface in the subprogram of the data packet returning operation is continuous code segments, it may be easy for the parameter information obtaining unit 112 to obtain all information of each call interface, that is, the information between the entry instruction and the exit instruction may be all the information of the call interface, so the parameter information obtaining unit 112 may only need to obtain the entry instruction and the exit instruction of each call interface. In instances when the subprogram of the data packet returning operation is non-continuous code segments, the parameter information obtaining unit 112 may obtain the information of the call interface according to the displacement information generated when calling the call interface in the execution trace.

The dividing unit 122 may be adapted to divide information of a send buffer corresponding to the subprogram of the data packet returning operation extracted by the return program extracting unit 11 into multiple components.

The semantic information determining unit 132 may be adapted to determine and output semantic information of each component divided by the dividing unit 122 based on the information of each parameter of the call interface obtained by the parameter information obtaining unit 112,

In determining the semantic information, the taint propagation technology may be adopted, that is, the semantic information determining unit 132 may first taint each parameter of each call interface included in the subprogram of the data packet returning operation, and then observe which parameters are propagated to the address space of the send buffer corresponding to the subprogram of the data packet returning operation. In instances when there is a parameter which is propagated to the send buffer and the length of this parameter is the same as the length of a cell divided by the dividing unit 122, the semantic information of this cell in the send buffer may be semantic information of a tainted parameter, and the semantic information of the parameter may be obtained by the parameter information obtaining unit 112.

In tainting each parameter of each call interface, the semantic information determining unit 132 may begin from the first address of the parameter of the call interface, and the entire address space that the parameter locates may be tainted, for example, each byte of the parameter may be tainted, and the granularity of the taint is in byte level, such that each byte may have an unique taint mark. For example, the parameter of a call interface includes 4 bytes, and the 4 bytes of the parameter are marked with different taint marks respectively.

In the computer system provided by the embodiment, the execution trace including information of each execution instruction may be obtained by the process executing unit 110, the control input unit 120 and the execution obtaining unit 130 in the trace capturing unit 10. The subprogram of the data packet returning operation may be extracted by the return program extracting unit 11 from the execution trace obtained by the execution obtaining unit 130. The semantic information analyzing unit 12 may analyze and then output the semantic information.

As shown in FIG. 11, in another embodiment, besides the structure shown in FIG. 9, the computer system may further include a partitioning unit 13, and the return program extracting unit 11 may include a call relationship graph determining unit 111 and a searching unit 121.

The partitioning unit 13 may be adapted to partition the execution trace captured by the trace capturing unit 10 at an interface for outputting a returned data packet to obtain multiple sub execution traces. Each sub execution trace may include an execution trace which is from receiving a data packet from the control host to outputting a returned data packet to the control host by the computer system. The captured execution trace may include information about multiple execution commands, and the return program extracting unit 11 may extract the subprograms of the data packet returning operation from any sub execution trace.

The call relationship graph determining unit 111 may be adapted to determine a call relationship graph which represents call relationship among call interfaces in executing the spyware process by the computer system based on the information of multiple execution instructions. Specifically, the call relationship graph determining unit 111 may search the call instructions from an outer layer to an inner layer and search the ret instructions from the inner layer to the outer layer according to the sequence of the entry instruction which may comprise a call instruction and the exit instruction which may comprise a ret instruction. In this manner instruction pairs may be paired, and each instruction pair may correspond to a call interface.

The searching unit 121 may be adapted to search the call relationship graph determined by the call relationship graph determining unit 111 for a second call interface which affects the first call interface for outputting the returned data packet, and identify information of the first call interface for outputting the returned data packet and the second call interface which affects the first call interface for outputting the returned data packet as the subprogram of the data packet returning operation.

After the trace capturing unit 10 obtains the execution trace including information of multiple execution instructions, the call relationship graph determining unit 111 in the return program extracting unit 11 may determine the call relationship graph based on the information of the multiple execution instructions. In addition, in order to simplify the analysis process, after the trace capturing unit 10 obtains the execution trace, the partitioning unit 13 may partition the execution trace to obtain multiple sub execution traces, then the call relationship graph determining unit 111 in the return program extracting unit 11 may determine the call relationship graph based on the information of the multiple execution instructions obtained from the multiple sub execution traces, and the finally-obtained call relationship graph of each sub execution trace may represent the call of the interfaces from receiving a data packet from the control host to outputting a returned data packet to the control host by the computer system.

After the call relationship graph determining unit 111 determines the call relationship graph, the searching unit 121 may search for the subprograms of the data packet returning operation by a dynamic slicing method; and the semantic information analyzing unit 12 may analyze the semantic information from each component in the subprogram of the data packet returning operation.

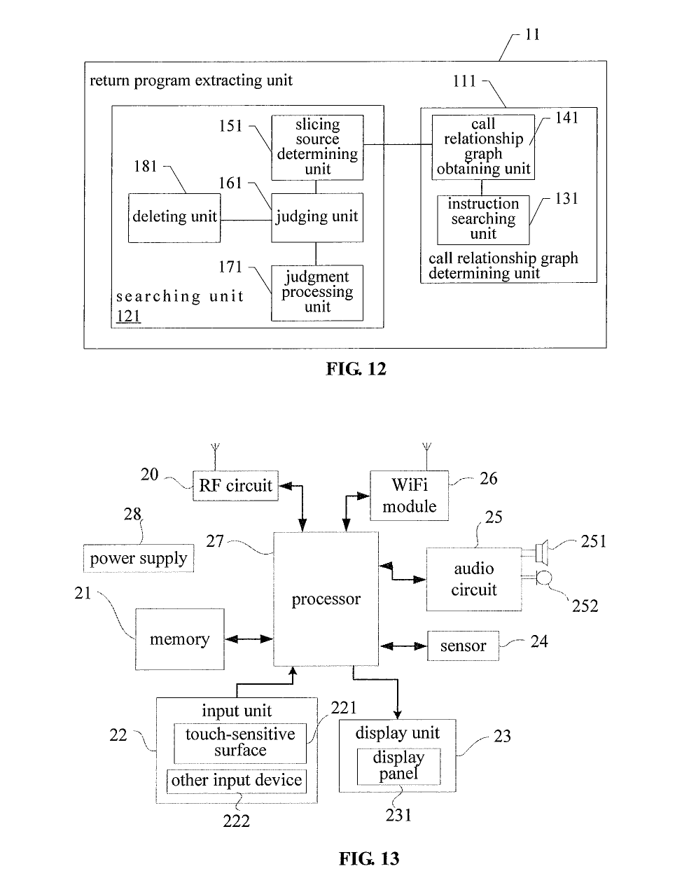

As shown in FIG. 12, the call relationship graph determining unit 111 may include an instruction searching unit 131 and a call relationship graph obtaining unit 141, and the searching unit 121 may include a slicing source determining unit 151, a judging unit 161, a judgment processing unit 171 and a deleting unit 181.

The instruction searching unit 131 may be adapted to search the multiple execution instructions included in the execution trace (or the sub execution trace obtained by the partitioning unit 13) captured by the trace capturing unit 10 for an entry instruction and an exit instruction for calling each interface.

The call relationship graph obtaining unit 141 may be adapted to identify or obtain the entry instruction or the exit instruction searched out by the instruction searching unit 131 as a call node, and connect the call nodes having call relationship with a call line.

The slicing source determining unit 151 may be adapted to determine that the dynamic slicing source is the entry instruction of the first call interface for outputting a returned data packet in the call relationship graph determined by the call relationship graph determining unit 111. The slicing source determining unit 151 may first determine the entry address of the first call interface for outputting the returned data packet in the execution trace, such as an instruction register (EIP) of the send function, i.e., 0x71a24c27; then search the call relationship graph for the entry instruction corresponding to the entry address, which may comprise a call node in the call relationship graph.

The judging unit 161 may be adapted to judge whether a call of a second call interface in the call relationship graph affects the call of the dynamic slicing source determined by the slicing source determining unit 151.

The judgment processing unit 171 may be adapted to identify an entry instruction of the second call interface as the dynamic slicing source and trigger the judging unit 161 to perform further judging in instances when the judging unit 161 judges that the call of the second call interface affects the call of the dynamic slicing source.

The deleting unit 181 may be adapted to delete the entry instruction of the second call interface from the call relationship graph in instances when the judging unit 161 judges that the call of the second call interface does not affect the call of the dynamic slicing source.

The judging unit 161, the judgment processing unit 171 and the deleting unit 181 may perform the dynamic slicing recursively until the entry instruction of each call node in the call relationship graph are judged by the judging unit 161.

The method and system for analyzing spyware may be applied to a terminal according to an embodiment of the disclosure. The terminal may include, for example, a smart phone, a tablet PC, an e-book reader, an MP3 (Moving Picture Experts Group Audio Layer III) player, an MP4 (Moving Picture Experts Group Audio Layer IV) player, a laptop and a desktop computer.

FIG. 13 is a schematic structure diagram of a terminal in accordance with an embodiment of the disclosure.

The terminal may include, for example, a RF (Radio Frequency) circuit 20, a memory 21 with one or more computer-readable storage medium, an input unit 22, a display unit 23, a sensor 24, an audio circuit 25, a WiFi (wireless fidelity) module 26, a processor 27 with one or more processing cores, and a power supply 28. Those skilled in the art may understand that the terminal structure shown in FIG. 13 does not limit the terminal, and the terminal may include more or less components, or combined components, or differently-arranged components compared with those shown in FIG. 13.

The RF circuit 20 may be adapted to receive and transmit signals in information receiving and transmitting and telephone communication. Specifically, the RF circuit delivers the received downlink information of the base station to one or more processor 27 to be processed, and transmits the uplink data to the base station. Generally, the RF circuit 20 includes but not limited to an antenna, at least one amplifier, a tuner, one or more oscillators, a subscriber identity module (SIM) card, a transceiver, a coupler, a Low Noise Amplifier (LNA), and a duplexer. In addition, the RF circuit 20 may communicate with other devices via wireless communication and network. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), E-mail, and Short Messaging Service (SMS).

The memory 21 may be adapted to store software programs and modules, and the processor 27 may execute various function applications and data processing by running the software programs and modules stored in the memory 21. The memory 21 may mainly include a program storage area and a data storage area, where the program storage area may be used to store, for example, the operating system and the application required by at least one function (for example, voice playing function, image playing function), and the data storage area may be used to store, for example, data established according to the use of the terminal (for example, audio data, telephone book). In addition, the memory 21 may include a high-speed random access memory and a nonvolatile memory, such as at least one magnetic disk memory, a flash memory, or other volatile solid-state memory. Accordingly, the memory 21 may also include a memory controller to provide access to the memory 21 for the processor 27 and the input unit 22.

The input unit 22 may be adapted to receive input numeric or character information, and to generate a keyboard, a mouse, a joystick, an optical or trackball signal input related to user setting and function control. In a specific embodiment, the input unit 22 may include a touch-sensitive surface 221 and other input device 222. The touch-sensitive surface 221 may also be referred to as a touch display screen or a touch pad, and may collect a touch operation thereon or thereby (for example, an operation on or around the touch-sensitive surface 221 that is made by the user with a finger, a touch pen and any other suitable object or accessory), and drive corresponding connection devices according to a preset procedure. Optionally, the touch-sensitive surface 221 may include a touch detection device and a touch controller. The touch detection device detects touch orientation of the user, detects a signal generated by the touch operation, and transmits the signal to the touch controller. The touch controller receives touch information from the touch detection device, converts the touch information into touch coordinates and transmits the touch coordinates to the processor 27. The touch controller may also be operable to receive a command transmitted from the processor 27 and execute the command. In addition, the touch-sensitive surface 221 may be implemented by, for example, a resistive surface, a capacitive surface, an infrared surface and a surface acoustic wave surface. In addition to the touch-sensitive surface 221, the input unit 22 may also include other input device 222. Specifically, the other input device 222 may include but not limited to one or more of a physical keyboard, a function key (such as a volume control button, a switch button), a trackball, a mouse and a joystick.

The display unit 23 may be adapted to display information input by the user or information provided for the user and various graphical user interfaces (GUI) of the terminal, these GUIs may be formed by a graph, a text, an icon, a video and any combination thereof. The display unit 23 may include a display panel 231. Optionally, the display panel 231 may be formed in a form of a Liquid Crystal Display (LCD), an Organic Light-Emitting Diode (OLED) or the like. In addition, the display panel 231 may be covered by the touch-sensitive surface 221. When the touch-sensitive surface 221 detects a touch operation thereon or thereby, the touch-sensitive surface 221 transmits the touch operation to the processor 27 to determine the type of the touch event, and then the processor 27 provides a corresponding visual output on the display panel 231 according to the type of the touch event. Although the touch-sensitive surface 221 and the display panel 231 implementing the input and output functions as two separate components in FIG. 13, the touch-sensitive surface 221 and the display panel 231 may be integrated together to implement the input and output functions in another embodiment.

The terminal may further include at least one sensor 24, such as an optical sensor, a motion sensor and other sensors. The optical sensor may include an ambient light sensor and a proximity sensor. The ambient light sensor may adjust the luminance of the display panel 231 according to the intensity of ambient light, and the proximity sensor may close the backlight or the display panel 231 when the terminal is approaching to the ear. As a kind of motion sensor, the gravity acceleration sensor may detect the magnitude of acceleration in multiple directions (usually three-axis directions) and detect the value and direction of the gravity when the sensor is in the stationary state. The acceleration sensor may be applied in, for example, an application of mobile phone pose recognition (for example, switching between landscape and portrait, a correlated game, magnetometer pose calibration), a function about vibration recognition (for example, a pedometer, knocking). Other sensors such as a gyroscope, a barometer, a hygrometer, a thermometer, an infrared sensor, which may be further provided in the terminal, are not described herein.

The audio circuit 25, a loudspeaker 251 and a microphone 252 may provide an audio interface between the user and the terminal. The audio circuit 25 may transmit an electric signal, converted from received audio data, to the loudspeaker 251, and a voice signal is converted from the electric signal and then outputted by the loudspeaker 251. The microphone 252 converts captured voice signal into an electric signal, the electric signal is received by the audio circuit 25 and converted into audio data. The audio data is outputted to the processor 27 for processing and then sent to another terminal via the RF circuit 20; or the audio data may be output to the memory 21 for further processing. The audio circuit 25 may further include an earphone jack to provide communication between the earphone and the terminal.

WiFi is a short-range wireless transmission technique. The terminal may, for example, send and receive E-mail, browse a webpage and access a streaming media for the user by the WiFi module 26, and provide wireless broadband Internet access for the user. Although the WiFi module 26 is shown in FIG. 13, it can be understood that the WiFi module 26 is not necessary for the terminal, and may be omitted as needed within the scope of the disclosure.

The processor 27 is a control center of the terminal, which connects various parts of the mobile phone by using various interfaces and wires, and implements various functions and data processing of the terminal by running or executing the software programs and/or modules stored in the memory 21 and invoking data stored in the memory 21, thereby monitoring the mobile phone as a whole. Optionally, the processor 27 may include one or more processing cores. Preferably, an application processor and a modem processor may be integrated into the processor 27. The application processor is mainly used to process, for example, an operating system, a user interface and an application. The modem processor is mainly used to process wireless communication. It can be understood that, the above modem processor may not be integrated into the processor 27.

The terminal also includes a power supply 28 (such as a battery) for powering various components. Preferably, the power supply may be logically connected with the processor 27 via a power management system, therefore, functions such as charging, discharging and power management are implemented by the power management system. The power supply 28 may also include one or more of a DC or AC power supply, a recharging system, a power failure detection circuit, a power converter or an inverter, a power status indicator and any other assemblies.

Although not shown, the terminal may also include other modules such as a camera and a Bluetooth module, which are not described herein. Specifically, in the embodiment, the processor 27 in the terminal may execute one or more application processes stored in the memory 21 according to the following instructions, to achieve various functions:

capturing an execution trace of a spyware process executed by the processor 27;

extracting a subprogram of a data packet returning operation from the execution trace, where the data packet returning operation may be an operation of transmitting a data packet to a control host in executing the spyware process by the processor 27, and the subprogram of the data packet returning operation may include information of multiple call interfaces; and

analyzing and outputting semantic information of each component of the information of the call interface.

In capturing the execution trace of the spyware process executed by the computer system, the processor 27 may be triggered to execute the spyware process; a control command for the spyware process may be input and a binary execution trace executed by the processor 27 for monitoring of the control command. The control command and information of each execution instruction included in the data packet returning operation corresponding to the control command may be obtained based on the binary execution trace.

In analyzing and outputting the semantic information of each component of the information of the call interface, the processor 27 may obtain information of each parameter of each call interface in the subprogram of the data packet returning operation; divide the information of the send buffer corresponding to the subprogram of the data packet returning operation into multiple components; determine and output the semantic information of each component based on the obtained information of each parameter of the call interface. In obtaining the information of each parameter of the call interface, the processor 27 may search the subprogram of the data packet returning operation for information of each call interface; search an interface database for prototype information of the call interface, and obtain information of each parameter of the call interface based on the prototype information. In searching for the information of the call interface, if the subprogram of the data packet returning operation is non-continuous code segments, the processor 27 may search the subprogram of the data packet returning operation for information of each call interface, and specifically, search for the information of the call interface based on displacement information generated when calling the call interface in the execution trace.

Further, in order to simplify the analyzing process, after the processor captures the execution trace of the spyware process executed by the processor 27, the processor may partition the execution trace at an interface for outputting a returned data packet to obtain multiple sub execution traces. The extracting of the subprograms of the data packet returning operation from the execution trace may include extracting the subprogram of the data packet returning operation from any sub execution trace.

In instances when the captured execution trace includes information of multiple execution instructions, the processor 27 may extract the subprogram of the data packet returning operation from the execution trace, including: determining a call relationship graph which represents call relationships among call interfaces in executing the spyware process by the processor 27 based on the information of the multiple execution instructions; searching the call relationship graph for a second call interface which affects the first call interface for outputting a returned data packet, and identifying or taking information of the first call interface for outputting the returned data packet and the second call interface which affects the first interface for outputting the returned data packet as the subprogram of the data packet returning operation.

(1) The processor 27 may determine a call relationship graph which represents call relationships among the call interfaces in executing the spyware process by the processor 27 based on the information of the multiple execution instructions, including: searching for the entry instruction and exit instruction for calling each interface in the multiple instructions, identifying or obtaining the entry instruction or exit instruction as a call node, and connecting the call nodes having a call relationship with a call line.

(2) The processor 27 may search the call relationship graph for a second call interface which affects the first call interface for outputting a returned data packet, including: determining that a dynamic slicing source is the entry instruction of the first call interface for outputting the returned data packet in the call relationship graph; judging whether the call of the second call interface affects the call of the dynamic slicing source, identifying the entry instruction of the second call interface as the dynamic slicing source and returning to perform the judging as to whether the call of a second call interface affects the call of the dynamic slicing source; and deleting the entry instruction of the second call interface from the call relationship graph if the call of the second call interface does not affect the call of the dynamic slicing source.

Those skilled in the art may understand that all or part of the processes of the method in the above embodiments may be realized by instructing the related hardware by a program, the program may be stored in a computer-readable storage medium which may include read-only memory (ROM), random access memory (RAM), disk, optical disk, etc.

The method for analyzing spyware and the computer system provided by the embodiments of the disclosure are described above, and specific examples are adopted herein to illustrate the principle and embodiments of the disclosure. The description of the embodiments is only to facilitate understanding of the method and core concept of the disclosure; meanwhile, amendments may be made on the embodiments and applications by those skilled in the art based on the concept of the disclosure. In conclusion, this disclosure does not limit the invention.

1. A method for analyzing spyware, comprising:
capturing an execution trace of a spyware process executed by a computer system;
extracting a subprogram of a data packet returning operation from the execution trace, wherein the data packet returning operation is an operation that transmits a data packet to a control host as a result of executing the spyware process by the computer system, and the subprogram of the data packet returning operation comprises information of at least one call interface; and
analyzing and outputting semantic information from each component of the information of the at least one call interface.

2. The method for analyzing spyware according to claim 1, wherein the capturing the execution trace of the spyware process executed by the computer system comprises:
triggering the computer system to execute the spyware process;
inputting a control command for the spyware process and monitoring a binary execution trace executed by the computer system for the control command; and
obtaining, based on the binary execution trace, the control command and information about each execution instruction included in the data packet returning operation corresponding to the control command.

3. The method for analyzing spyware according to claim 1, wherein the method further comprises, after capturing the execution trace of the spyware process executed by the computer system,
partitioning the execution trace at a first call interface for outputting a returned data packet, to obtain a plurality of sub execution traces; and
the extracting a subprogram of the data packet returning operation from the execution trace comprises extracting the subprogram of the data packet returning operation from any of the plurality of sub execution traces.

4. The method for analyzing spyware according to claim 1, wherein the execution trace comprises information about a plurality of execution instructions; and in a case where the number of the at least one call interface is more than one, the extracting the subprogram of a data packet returning operation from the execution trace comprises:
determining, based on the information about the plurality of execution instructions, a call relationship graph which represents call relationships among the call interfaces called in in the execution of the spyware process by the computer system;
searching the call relationship graph for a second call interface which affects a first call interface for outputting a returned data packet, and identifying information of the first call interface for outputting the returned data packet and the second call interface which affects the first call interface for outputting the returned data packet, as the subprogram of the data packet returning operation.

5. The method for analyzing spyware according to claim 4, wherein the determining, based on the information about the plurality of execution instructions, the call relationship graph which represents call relationships among the call interfaces called in executing the spyware process by the computer system comprises:
searching the plurality of execution instructions for an entry instruction and an exit instruction for calling the call interfaces; and
identifying the entry instruction or the exit instruction as a call node, and connecting call nodes having a call relationship with a call line.

6. The method for analyzing spyware according to claim 4, wherein the searching the call relationship graph for the second call interface which affects the first call interface for outputting the returned data packet comprises:
determining that a dynamic slicing source is an entry instruction of the first call interface for outputting the returned data packet in the call relationship graph;
judging whether a call of the second call interface affects a call of the dynamic slicing source; and
in instances when the call of the second call interface affects the call of the dynamic slicing source:
identifying an entry instruction of the second call interface as the dynamic slicing source and judging whether a call of another second call interface affects a call of the dynamic slicing source, and
in instances when the call of the second call interface does not affect the call of the dynamic slicing source:
deleting the entry instruction of the second call interface from the call relationship graph.

7. The method for analyzing spyware according to claim 1, wherein the analyzing and outputting semantic information from each component of the information of the at least one call interface comprises:
obtaining information about each parameter of the at least one call interface;
dividing information of a send buffer that corresponds to the subprogram of the data packet returning operation, into a plurality of components; and
determining and outputting semantic information from each of the plurality of components based on the information about each parameter of the at least one call interface.

8. The method for analyzing spyware according to claim 7, wherein the obtaining information about each parameter of the at least one call interface comprises:
searching the subprogram of the data packet returning operation for the information of the at least one call interface; and
searching a call interface database for prototype information of the at least one call interface, and obtaining the information about each parameter of the at least one call interface based on the prototype information.

9. The method for analyzing spyware according to claim 8, wherein, in instances when the subprogram of the data packet returning operation comprises non-continuous code segments, the searching the subprogram of the data packet returning operation for the information of the at least one call interface comprises:
searching for the information of the at least one call interface based on displacement information generated when calling the at least one call interface, in the execution trace.

10. A computer system, comprising:
a trace capturing unit, adapted to capture an execution trace of a spyware process executed by a computer system;
a return program extracting unit, adapted to extract a subprogram of a data packet returning operation from the execution trace, wherein the data packet returning operation is an operation that transmits a data packet to a control host as a result of executing the spyware process by the computer system, and the subprogram of the data packet returning operation comprises information of at least one call interface; and
a semantic information analyzing unit, adapted to analyze and output semantic information from each component of the information of the at least one call interface.

11. The computer system according to claim 10, wherein the trace capturing unit comprises:
a process executing unit, adapted to trigger the computer system to execute the spyware process;
a control input unit, adapted to input a control command for the spyware process and monitor a binary execution trace executed by the computer system for the control command; and
an execution obtaining unit, adapted to obtain, based on the binary execution trace, the control command and information about each execution instruction included in the data packet returning operation corresponding to the control command.

12. The computer system according to claim 10, further comprising:
a partitioning unit, adapted to partition the execution trace at a first call interface for outputting a returned data packet, to obtain a plurality of sub execution traces,
wherein the return program extracting unit is further adapted to extract the subprogram of the data packet returning operation from any of the sub execution traces.

13. The computer system according to claim 10, wherein the execution trace comprises information about a plurality of execution instructions; and in a case where the number of the at least one call interface is more than one, the return program extracting unit comprises:
a call relationship graph determining unit, adapted to determine, based on the information about the plurality of execution instructions, a call relationship graph which represents call relationships among the call interfaces called in the execution of the spyware process by the computer system; and
a searching unit, adapted to search the call relationship graph for a second call interface which affects a first call interface for outputting a returned data packet, and identify information of the first call interface for outputting the returned data packet and the second call interface which affects the first call interface for outputting the returned data packet as the subprogram of the data packet returning operation.

14. The computer system according to claim 13, wherein the call relationship graph determining unit comprises:
an instruction searching unit, adapted to search the plurality of execution instructions for an entry instruction and an exit instruction for calling the call interfaces; and
a call relationship graph obtaining unit, adapted to identify the entry instruction or the exit instruction as a call node, and connect the call nodes having call relationship with a call line.

15. The computer system according to claim 13, wherein the searching unit comprises:
a slicing source determining unit, adapted to determine that a dynamic slicing source is an entry instruction of the first call interface for outputting the returned data packet in the call relationship graph;
a judging unit, adapted to judge whether a call of the second call interface affects a call of the dynamic slicing source; and
a judgment processing unit, adapted to:
in instances when the judging unit judges that the call of the second call interface affects the call of the dynamic slicing source:
identify an entry instruction of the second call interface as the dynamic slicing source; and
trigger the judging unit to judge whether a call of another second call interface affects a call of the dynamic slicing source; and
a deleting unit, adapted to delete the entry instruction of the second call interface from the call relationship graph in instances when the judging unit judges that the call of the second call interface does not affect the call of the dynamic slicing source.

16. The computer system according to claim 10, wherein the semantic information analyzing unit comprises:
a parameter information obtaining unit, adapted to obtain information about each parameter of the at least one call interface in the subprogram of the data packet returning operation;
a dividing unit, adapted to divide information of a send buffer corresponding to the subprogram of the data packet returning operation into a plurality of components; and
a semantic information determining unit, adapted to determine and output semantic information from each of the plurality of components based on the information about each parameter of the at least one call interface in the subprogram of the data packet returning operation.

17. The computer system according to claim 16, wherein the parameter information obtaining unit is adapted to search the subprogram of the data packet returning operation for the information of the at least one call interface, search a call interface database for prototype information of the at least one call interface, and obtain information about each parameter of the at least one call interface based on the prototype information.

18. The computer system according to claim 17, wherein the parameter information obtaining unit is adapted to, in instances when the subprogram of the data packet returning operation comprises non-continuous code segments, search the subprogram of the data packet returning operation for the information of the at least one call interface based on displacement information generated when calling the at least one call interface, in the execution trace.

19. A non-transitory computer-readable medium storing a computer program, wherein execution of the computer program comprises:
capturing an execution trace of a spyware process executed by a computer system;
extracting a subprogram of a data packet returning operation from the execution trace, wherein the data packet returning operation is an operation that transmits a data packet to a control host as a result of executing the spyware process by the computer system, and the subprogram of the data packet returning operation comprises information of at least one call interface; and
analyzing and outputting semantic information from each component of the information of the at least one call interface.

20. The non-transitory computer-readable medium storing the computer program according to claim 19, wherein the capturing an execution trace of a spyware process executed by the computer system comprises:
triggering the computer system to execute the spyware process;
inputting a control command for the spyware process and monitoring a binary execution trace executed by the computer system for the control command; and
obtaining, based on the binary execution trace, the control command and information about each execution instruction included in the data packet returning operation corresponding to the control command.
